(19) United States
(12) Patent Application Publication
(10) Pub. No.: US 2025/0008167 A1
(43) Pub. Date: Jan. 2, 2025

(54) TERMINAL, METHOD AND NON-TRANSITORY COMPUTER-READABLE MEDIUM INCLUDING PROGRAM INSTRUCTIONS

(71) Applicant: 17LIVE Japan Inc., Tokyo (JP)

(72) Inventors: Wei-Hsiang HUNG, Taipei City (TW); Po-Yi KUO, Taipei City (TW); Che-Wei HU, Taipei City (TW); Tsung-Tai SHIH, Taipei City (TW)

(21) Appl. No.: 18/530,888

(22) Filed: Dec. 6, 2023

(30) Foreign Application Priority Data
Jun. 28, 2023 (JP) 2023-105876

(51) Int. Cl. H04N 21/2187; H04N 21/231

(52) U.S. Cl. CPC H04N 21/2187; H04N 21/23106

(57) ABSTRACT

A terminal for handling data in a live streaming platform, including one or a plurality of processors, wherein the one or plurality of processors execute a machine- readable instruction to perform: transmitting a request on a portion of data; receiving a response of the request; setting a retry count in response to the response being failed and the portion of data being not the first portion; determining retry time according to the set retry count; and transmitting a next request on the portion of data after the retry time. According to the present disclosure, the requested data, such as the leaderboard data, may be displayed smoothly to the user terminal regardless of the network condition, rather than showing a blank screen. Therefore, the user experience may be improved.

### CROSS-REFERENCE TO RELATED APPLICATIONS

This application is based on and claims the benefit of priority from Japanese Patent Application Serial No. 2023-105876 (filed on Jun. 28, 2023), the contents of which are hereby incorporated by reference in their entirety.

### TECHNICAL FIELD

This disclosure relates to information and communication technology, and in particular, to a terminal, method and computer program in a live streaming.

### BACKGROUND

Some APPs or platforms provide live streaming service for livestreamers and viewers to interact with each other. The livestreamers may have a performance to cheer up the viewer and the viewer may donate or send gifts to support the livestreamers. Moreover, they also hold a variety of campaigns or events to attract more livestreamers and viewers to join the live streaming.

Since the interaction between livestreamers and viewers is real-time, the calculation and update of the data such as leaderboards is required to be fast and accurate. Chine U.S. Pat. No. 10,724,9140B disclosed a method for displaying the leaderboard cache to release the server load and improve the information timeliness.

However, the display of the data varies depending on the network condition of the user terminal. Moreover, if a blank screen is displayed while requesting the data, it may cause the user dissatisfaction, which may lead to poor user experience. Therefore, how to handle data from the network or cache is a very important issue.

### SUMMARY

An embodiment of subject application relates to a terminal for handling data in a live streaming platform, comprising one or a plurality of processors, wherein the one or plurality of processors execute a machine-readable instruction to perform: transmitting a request on a portion of data; receiving a response of the request; setting a retry count in response to the response being failed and the portion of data being not the first portion; determining retry time according to the set retry count; and transmitting a next request on the portion of data after the retry time.

Another embodiment of subject application relates to a method for handling data in a live streaming platform, comprising: transmitting a request on a portion of data; receiving a response of the request; setting a retry count in response to the response being failed and the portion of data being not the first portion; determining retry time according to the set retry count; and transmitting a next request on the portion of data after the retry time.

Another embodiment of subject application relates to a computer program for causing a terminal to realize the functions of: transmitting a request on a portion of data; receiving a response of the request; setting a retry count in response to the response being failed and the portion of data being not the first portion; determining retry time according to the set retry count; and transmitting a next request on the portion of data after the retry time.

According to the present disclosure, the requested data, such as the leaderboard data, may be displayed smoothly to the user terminal regardless of the network condition, rather than showing a blank screen. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the data DB 324 of FIG. 3;

FIG. 7 shows an exemplary data structure of the cache DB 250 of FIG. 2;

FIG. 8 shows an exemplary data structure of the data queue DB 252 of FIG. 2;

FIG. 9-FIG. 11 are exemplary screen images of a live-streaming room screen 660 shown on the display of the livestreamer user terminal 20 or the viewer user terminal 30;

FIG. 12-FIG. 15 are flowcharts showing steps of an application activation process on the user terminals 20 and 30;

FIG. 16 is a flowchart showing steps of determining retry time;

FIG. 17 shows an exemplary data structure of retry time look-up table 254 of FIG. 2;

FIG. 18 is a flowchart showing steps of determining refresh time;

FIG. 19 shows an exemplary data structure of refresh time look-up table 256 of FIG. 2;

FIG. 20 is an exemplary hardware configuration of the information processing device according to some embodiments of subject application.

### DESCRIPTION OF THE PREFERRED EMBODIMENTS

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

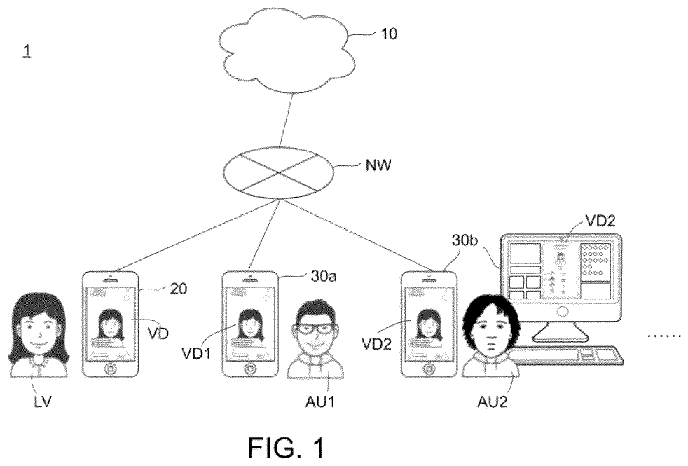

FIG. 1 shows a schematic configuration of a live streaming system 1 according to some embodiments of subject application. The live streaming system 1 provides a live streaming service for the streaming livestreamer (may also be referred as liver, streamer or distributor) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a livestreamer and the user terminal 30 may be a viewer. In some embodiments, the livestreamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the livestreamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the livestreamer and reproduced by the user terminal of the viewer via the server 10, the streaming data generated by the user terminal of the livestreamer, the streaming data passed through the server 10 and the streaming data received and reproduced by the by the user terminal of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the livestreamer LV, and the audio outputted from the terminal 30a, 30b may also be substantially the same as the audio recorded by the user terminal of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, video or audio from the terminal 30a, 30b of the viewer AU1, AU2, so that the communication of the livestreamer LV and viewer LV may be realized. Therefore, the live streaming system may realize the live streaming of two-way communication.

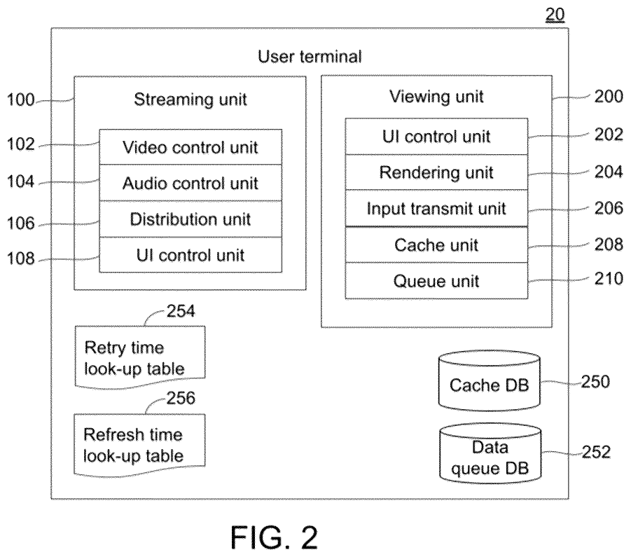

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as a livestreamer or be referred to as the user terminal which generates the streaming data. The user terminal who is activating the viewing unit 200 may be referred to as a viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204, input transmit unit 206, cache unit 208, queue unit 210, cache DB 250, data queue DB 252, retry time look-up table 254 and refresh time look-up table 256. The viewing unit 200 is configured to receive streaming data from server 10 via network NW.

The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing a user, voting in an event, gaming or the like. For example, the input transmit unit 206 may generate gift information and transmit to server 10 via the internet NW if the user terminal of the viewer clicks a gift object on the screen in order to send a gift to the livestreamer.

The cache unit 208 may be configured to handle the cache data. For example, the cache unit 208 may store the network data from the server 10 as cache data at the cache DB 250. The cache unit 208 may also retrieve the cache data from the cache DB 250 for displaying on the user terminal of the user. In some embodiments, the cache unit 208 may display the available cache data first once the user requests data by the user terminal. In some embodiments, the cache unit 208 may display the cache data if the network data from the server 10 is not available. In some embodiments, the cache unit 208 may also update, delete, modify the cache data or the like.

The queue unit 210 may be configured to handle the downloading of network data from the server 10. In some embodiments, the queue unit 210 may control the queue of downloading data at the data queue DB 252. More specifically, once the user requests data from the server 10, the queue unit 210 may store a data queue of the downloading data at the data queue DB 252 to control the downloading of the data.

The user may use the user terminal to request data from server 10. For example, if the terminal is a smartphone, the user may request live streaming data via APP or the like. If the terminal is a desktop PC, the user may request live streaming data via browser or the like. In some embodiments, the user may request a plurality of data from the live streaming platform. For example, the live streaming data in a streaming room or leaderboard data in an event may be requested. In some embodiments, the requested data may also be any possible data from the live streaming service.

Once the user accesses a page such as the leaderboard page, the queue unit 210 may start to request data from the server 10. The leaderboard may include a plurality of data such as description, rule and leaderboard of the event. The leaderboard may further include the ranking of the user and the current score they received or the like. In some embodiments, the current score may include a sub-page showing the composition of the score, bonuses obtained from the previous round or the like.

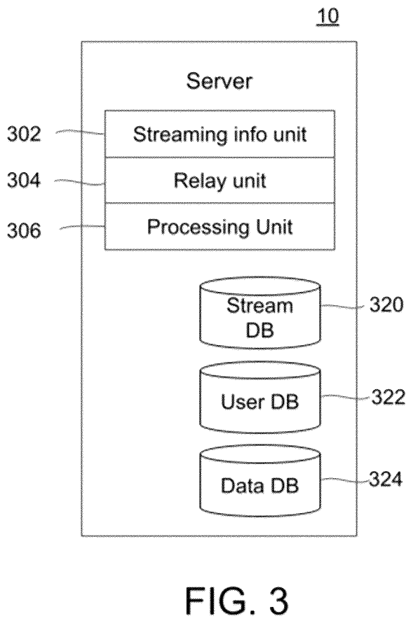

FIG. 3 is a schematic block diagram of the server 10 according to some embodiments of the subject application. The server 10 may include streaming info unit 302, relay unit 304, processing unit 306, stream DB 320, user DB 322 and data DB 324.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming. The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

The processing unit 306 is configured to process requests in response to operations from a user terminal of a user. For example, the user may click on the event list button to make a request on the event list. Once the relay unit 304 receives the request, the processing unit 306 may refer to the data DB 324 and retrieve the event list, and the processing unit 306 and the relay unit 304 may further transmit the event list to the user terminal of the user.

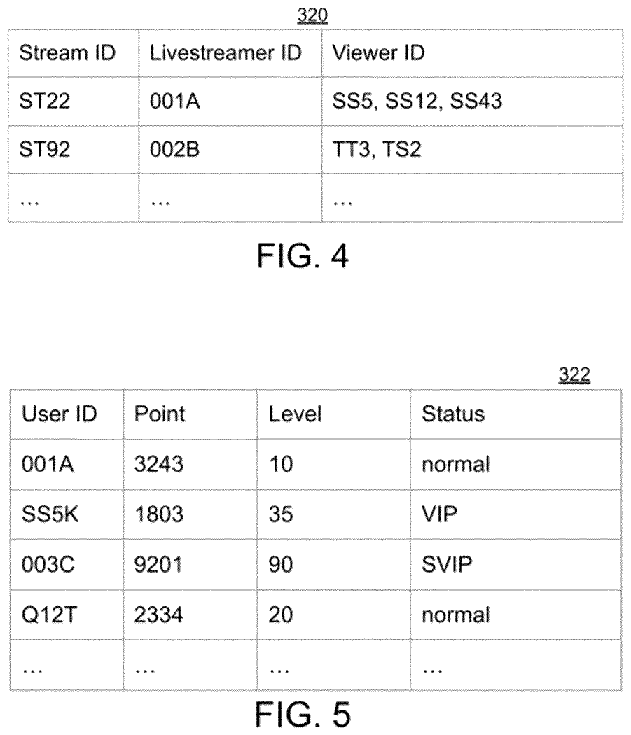

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a livestreamer ID for identifying the livestreamer who provides the live-stream, and a viewer ID for identifying a viewer of the live-stream, in association with each other.

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user in association with each other. The point is the electronic value circulated within the live-streaming platform. The level may be an indicator of the amount of user activity or engagement on the live streaming platform. The status may be an identity or membership status of the user on the live streaming platform.

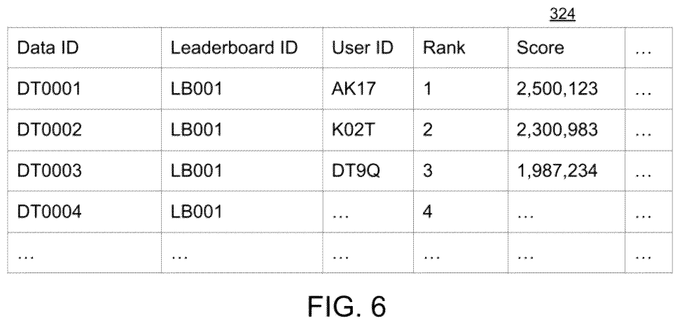

FIG. 6 shows an exemplary data structure of the data DB 324 of FIG. 3. The data DB 324 holds data information regarding a live stream in the live distribution platform. In some embodiments, the data in server 10 may be any possible data in a live streaming platform. Here, the leaderboard data in an event is taken as an example for explanation. The data DB 324 stores a data ID for identifying the data on a live distribution platform provided by the live-streaming system 1, and leaderboard ID for identifying a leaderboard of the data, in association with each other. The data DB 324 also stores user ID, rank and score for identifying the users in a leaderboard, their corresponding rank and score, in association with each other.

In some embodiments, the queue unit 210 may download the data from the server 10 either all at once or in batches. For example, if server 10 has 3,000 data entries, the queue unit 210 may batch download in increments of 100 entries at a time. In some embodiments, the queue unit 210 may determine order of the data downloading. The queue unit 210 may request the leaderboard data once getting access to the leaderboard page. For example, the queue unit 210 may download the data of top 10 users in the leaderboard, so the information of the leaderboard may be displayed on the viewer's terminal.

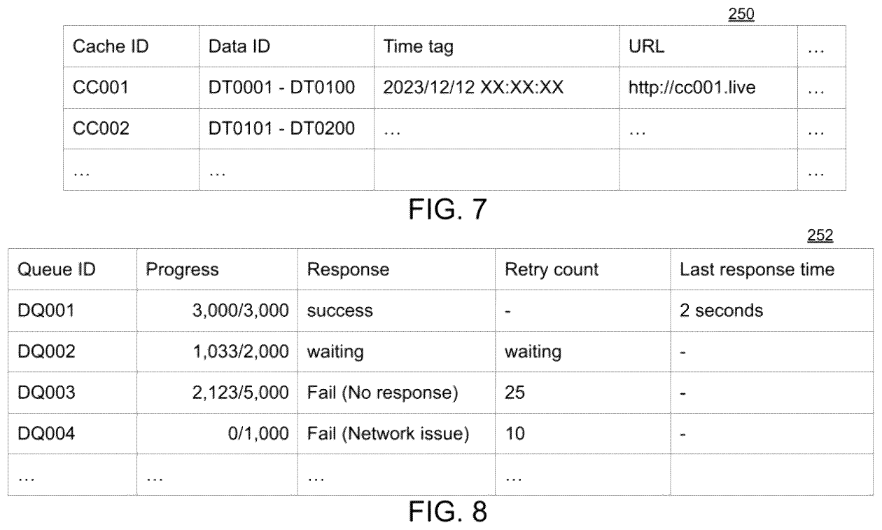

FIG. 7 shows an exemplary data structure of the cache DB 250 of FIG. 2. The cache DB 250 holds a cache data of the data from server 10. The cache DB 250 stores a cache ID and data ID for identifying a cache data and the corresponding data from server 10, time tag for identifying the time information of the cache data, the URL for identifying the location of the cache data, in association with each other. In some embodiments, the cache DB 250 may also include other detailed information of each data entry.

FIG. 8 shows an exemplary data structure of the data queue DB 252 of FIG. 2. The data queue DB 252 holds information regarding the queue of data downloaded by the user terminal of the user. The data queue DB 252 stores a queue ID, progress and response for identifying a queue of the downloading, its progress and response from the server 10, in association with each other. The data queue DB 252 also stores retry count for identifying number of times to request the corresponding data, last response time for identifying the time it takes for the server 10 to respond to a request from the user terminal of the user at the last time, in association with each other. In some embodiments, the response time may be measured according to the elapsed time between when a request is made and when the server sends a response back to the user terminal of the user.

In some embodiments, the progress may be the ratio of current data entry and total data entry to indicate the current progress of the download. In some embodiments, the progress may also include progress of each entry of data or each batch of data such as the progress of 1st-100th, 101st-200th entries of data or the like. In some embodiments, the last response time may be stored once a request is successful. In some embodiments, the last response time may also be stored once the request is failed for reference. In some embodiments, for the response of “Fail” due to “no response”, the threshold for determining “no response” may also be used as the last response time or the like.

In some embodiments, the response may be “Success” or “Fail”. The response of “Success” may refer to the requested data being successfully retrieved, processed and returned to the user terminal without errors or issues. On the other hand, the response of “Fail” may refer to the requested data being not successfully retrieved, processed and returned to the user terminal due to errors or issues. In some embodiments, the reason or error code of the response “Fail” may also be included in the response.

The reason for the response of “Fail” may be due to server unavailability, server load, network issue or the like. For example, if the server fails to provide any response within a reasonable or expected time frame, the response may be “Failed” and the reason may be “no response” or the like. In some embodiments, the reasonable or expected time frame for responding to the request may be at most three seconds, five seconds or determined flexibly according to the practical need. In some embodiments, the response may show “Waiting” to indicate that the request is in the processing stage and waiting for response or the like.

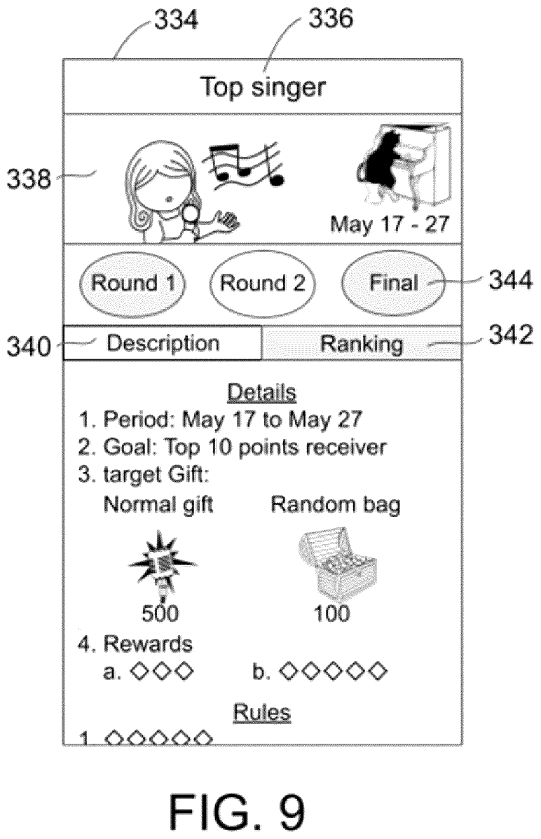

FIG. 9-FIG. 11 are exemplary screen images of a live-streaming room screen 600 shown on the display of the livestreamer user terminal 20 or the viewer user terminal 30.

FIG. 9 shows an exemplary event page 334. The viewer or livestreamer may click a button on the screen to request the event list. Once an event is selected, the corresponding event page 334 may be shown on the user terminal. As shown in FIG. 9, the event page 334 may include the title 336, banner 338, description 340 and ranking 342. In some embodiments, the event page 334 may include tab 344 to indicate the current stage of the event such as round 1, round 2, final or the like.

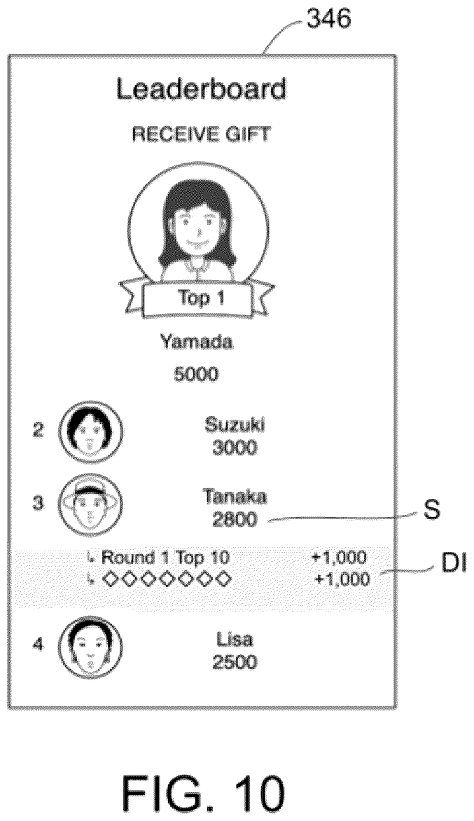

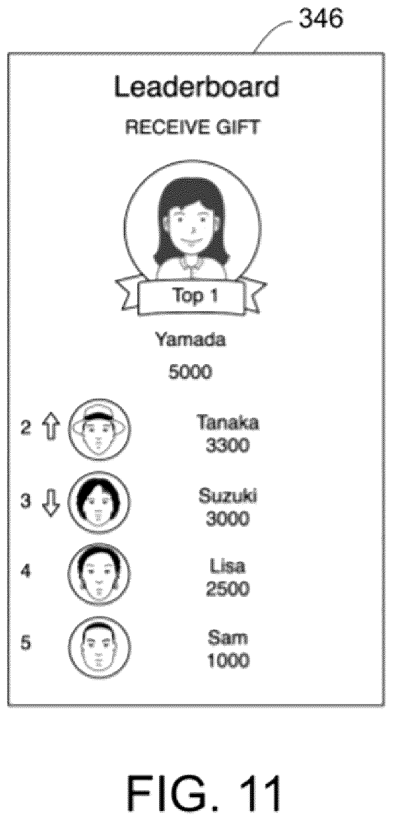

The user may click on the ranking 342 to check the current or historical leaderboard of the event. FIG. 10 and FIG. 11 shows an exemplary leaderboard page 346 of the ranking 342. In some embodiments, the leaderboard page 346 may display the ranking of the users and their corresponding score S. In some embodiments, detailed information DI of the score S may also be displayed below each user to indicate the information of the score in detail. For example, the detailed information DI may include score bonuses, score combination, or other relevant information.

In some embodiments, the livestreamers and viewers may access the leaderboard page 346 to check the current leaderboard. Once a plurality of users accesses the leaderboard page 346 to request data from the server 10, the server's load becomes very high. If the user could not receive data from the server 10, the leaderboard page 346 may be blank and lead to bad user experience. Therefore, the user terminal may first check if the requested data is available in the cache data DB 250. The terminal may further request network data from server 10 no matter whether cache data is displayed or not.

For some events, the competition is extremely intense. Especially for the last moment before the end of the event, it is always considered the most thrilling moment in an event. The viewers always gather with the livestreamer to support the livestreamer for the event. The viewers donate event gifts to the livestreamer and wait until the end of the event in order to let their favorite livestreamer win or achieve reward threshold in an event. Therefore, the information in the leaderboard page 346 may be very important and need to be retrieved and refreshed dynamically in real-time.

In some embodiments, a cache data of the leaderboard page 346 may be displayed on the user terminal as shown in FIG. 10. In some embodiments, the network data from the server 10 may be displayed and refreshed in real-time as shown in FIG. 11. According to the embodiments, the users may track the current rankings on the leaderboard page 346 and help their favorite livestreamers achieve victory. The way for displaying cache data, displaying network data and refreshing the data would be described later.

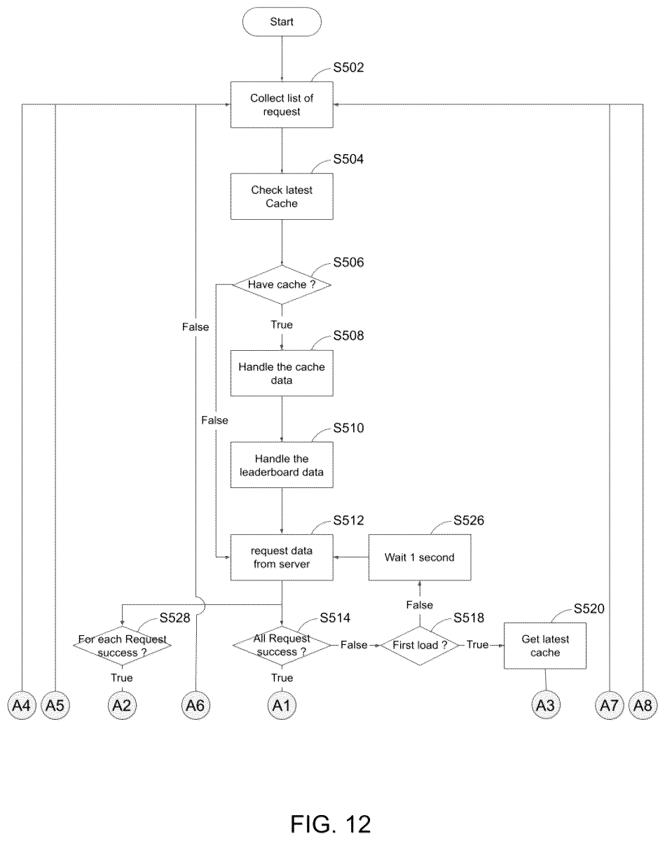

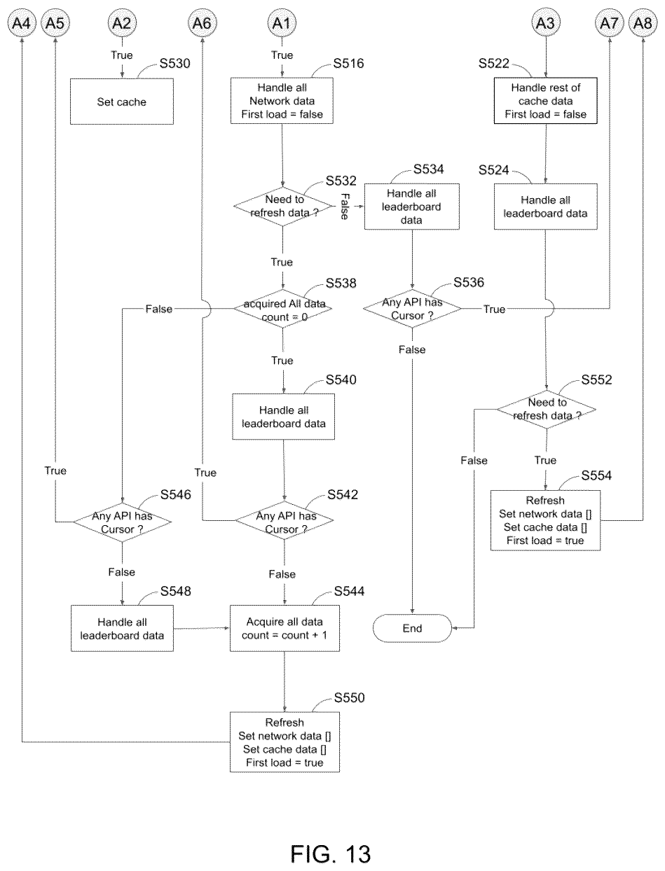

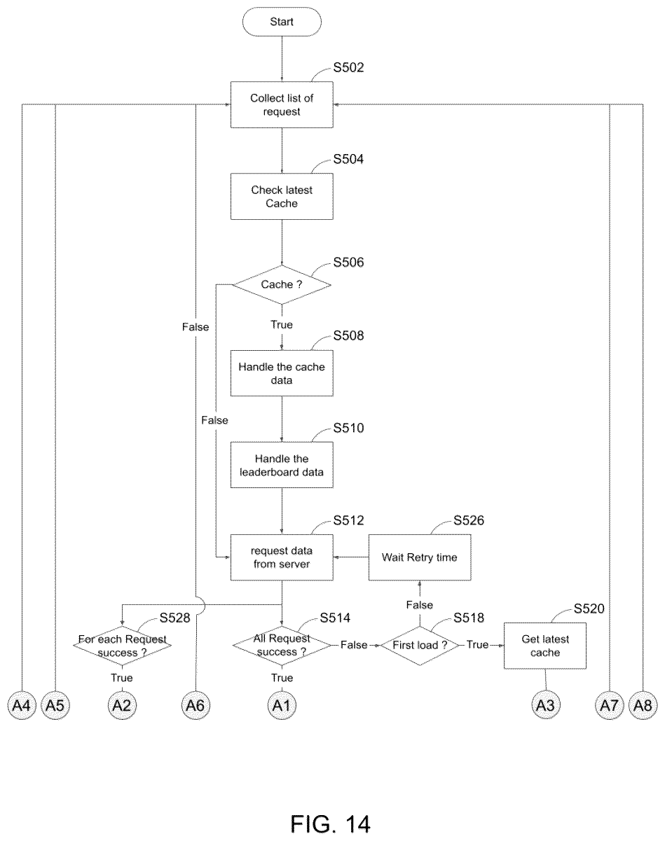

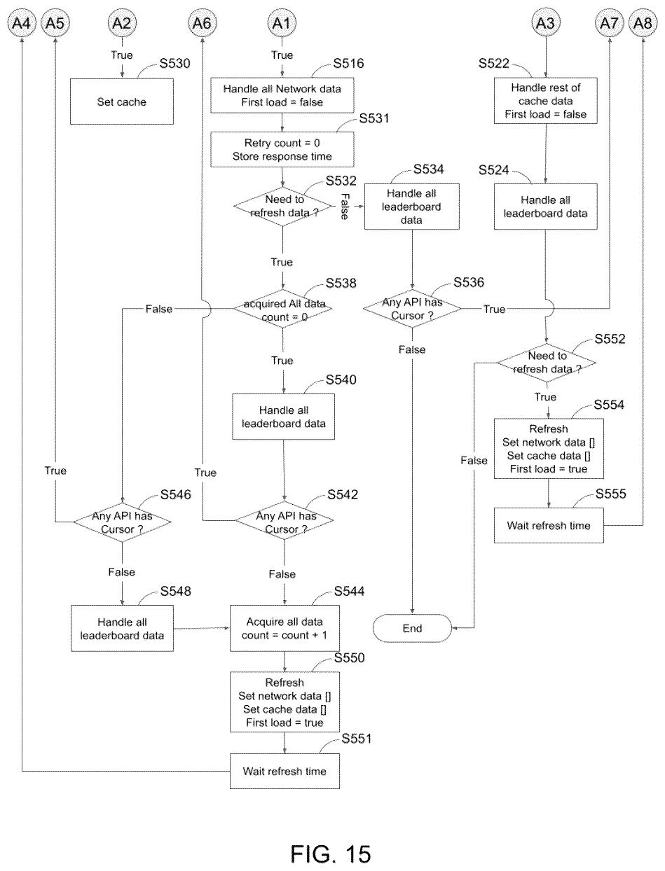

FIG. 12-FIG. 15 are flowcharts showing steps of an application activation process on the user terminals 20 and 30. More specifically, FIG. 12 and FIG. 13 is an embodiment of the live streaming system 1, and FIG. 14 and FIG. 15 is another embodiments of the live streaming system 1. The embodiment in FIG. 12 and FIG. 13 may be referred to as a related art compared with the embodiment in FIG. 14 and FIG. 15.

As shown in FIG. 12, 13 and FIG. 14, 15, the livestreamer may open the event page 334 or leaderboard page 346 to check the event description or leaderboard, and the user terminal may collect a list of requests for requesting data from the server 10 (S502). Once the collection of the request list is finished, the queue unit 210 may refer to the cache DB 250 to check whether there is the latest cache for the data in the request list (S504).

If there is the latest cache for the data in the request list (True in S504), the cache unit 208 may handle the cache data (S508). For example, the cache unit 208 may retrieve the latest cache data from the cache DB 250. In some embodiments, the rendering unit 204 may further handle the leaderboard data (S510). For example, the rendering unit 204 may render the latest cache data on the frame image and display on the user terminal of the user. According to the embodiments, the user may be able to see the cache data instead of seeing a blank page and the user experience may be improved.

More specifically, if there is cache data available, the corresponding cache data may be retrieved immediately. At this point, the screen will display the cache data of the data from the previous request. For example, if the previous session's first request fetched 100 records and the current session also requested 100 records, the screen will initially display the 1st-100th record of cache data from the previous session's data. In some embodiments, the remaining records of cache data may be pending, and the determination of displaying the remaining cache data would be made in the subsequent process. If there is no cache data available, the requested data would be displayed once being received from server 10.

After the leaderboard data is handled, the queue unit 210 may further request network data from the server 10 according to the request list (S512). In some embodiments, if there is no latest cache for the data in the request list (False in S506), the queue unit 210 may directly request data from the server 10 according to the request list (S512). In some embodiments, the cache data may be data from the cache DB 250. The network data may be data from the server 10. The leaderboard data may be the data displayed on the user terminal, which may be from the cache data or network data.

For example, if server 10 has 3,000 data entries, the queue unit 210 may batch download in increments of 100 entries at a time. The queue unit 210 may request 1st-100th entries of data at the first time. Before the queue unit 210 requests data from server 10, the cache unit 208 may check whether there is cache data of the corresponding 1st-100th entries of data in cache DB 250. If yes, the cache unit 208 may retrieve the cache data and the rendering unit 204 may display the cache of the 1st-100th data on the user terminal. If no, the queue unit 210 may request 1st-100th entries of data from the server 10.

If not all the requests of data are successful (False in S514), which means the request of 1st-100th data is not successful, the queue unit 210 may determine whether the status of the request is “First load” or not (S518). The status of “First load” may refer to the status of the request being disconnected at the beginning of the request. For example, if no data from the 1st-100th data is requested successfully, it may be referred to as the “First load”. It may refer to the situation where the user's user terminal is experiencing errors or encountering problems or the like.

If the request is “First load” (True in S518), the cache unit 208 may get the latest cache of the requested data (S520). For example, the cache unit 208 may retrieve the latest cache of the 1st-100th data from the cache DB 250. The cache unit 208 may further handle the rest of the cache data and set the parameter of “First load” as false (S522). For example, the cache unit 208 may further retrieve the cache data of the 101st-3,000th data from the cache DB 250. The rendering unit 204 may further handle all leaderboard data (S524) by, for example, displaying all the cache data on the user terminal.

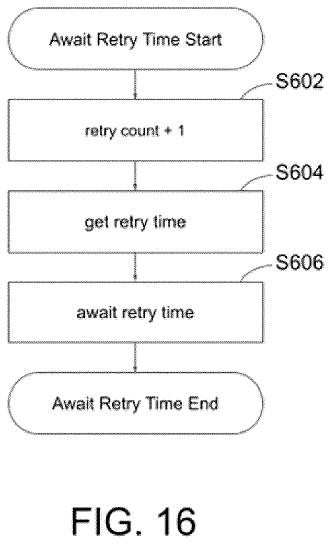

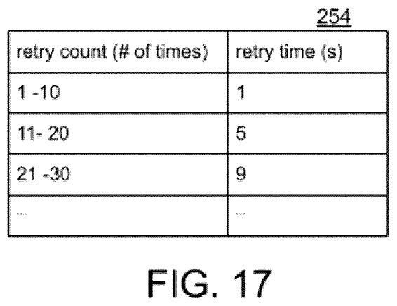

If the request is not “First load” (False in S518), the queue unit 210 may wait a retry time (S526) and further request data from the server 10 again according to the request list (S512). Here, the retry time may be referred to as the time span for the queue unit 210 to make the next request on the network data from the server 10. In some embodiments, the retry time may be a fixed time span such as 1 second or the like as shown in FIG. 12. In some embodiments, the retry time may be a non-fixed time span as shown in FIG. 14, FIG. 16 and FIG. 17. In some embodiments, the retry time may be determined flexibly according to the practical need.

FIG. 16 is a flowchart showing steps of determining retry time and FIG. 17 shows an exemplary data structure of retry time look-up table 254 of FIG. 2. In some embodiments, if the request is not “First load” (False in S518), the determination of retry time may be started. As shown in FIG. 16, the parameter of “retry count” may be increased by one (S602). Here, the “retry count” may refer to the number of times the queue unit 210 retries on requesting data from the server 10. The queue unit 210 may further get the retry time according to the retry count (S604). Then, the queue unit 210 may wait a retry time (S606) and further request data from the server 10.

The retry time look-up table 254 may be configured to store the relationship between the retry count and the retry time. As shown in FIG. 17 as an example, the retry time look-up table 254 may include retry count and its corresponding retry time, in association with each other. In some embodiments, a range or a value of retry counts may correspond to a value of retry time. For example, the number of retry counts “1-10”, “11-20” and “21-30” may correspond to the value of retry time “1”, “5” and “9” seconds or the like. In some embodiments, the retry count may be determined according to the response from the server 10. For example, the retry count may be increased by one if the response from the server 10 is not “success” or is “Fail”, which means that the terminal is encountering an issue for data retrieval.

In some embodiments, the retry time is either a fixed value or increases with the increase in retry count. In some embodiments, the retry time may be increased according to the number of times of requesting data from the server 10. In some embodiments, the retry time may be proportional to the retry count. In some embodiments, the retry time may follow an arithmetic sequence, geometric sequence, Fibonacci sequence or the like depending on the retry count. In some embodiments, the relationship between the retry count and retry time may be determined flexibly according to the practical need.

According to the embodiments, the retry time to wait before initiating the next retry for the request is determined based on the accumulated retry count. As the retry count increases (indicating multiple unsuccessful attempts with the backend), the retry time would yield a larger value, thereby extending the retry interval. Therefore, it helps alleviate the backend load.

More specifically, there are three scenarios discussed. First, if the data request is successful, the network condition of the user terminal may be referred to as the ideal or weak connection. In this situation, the cache data of the first portion of 1st-100th data may be displayed immediately in the beginning. Then, the terminal may handle the network data by updating the leaderboard, synchronizing the cache data, and then update the screen every 100 entries of data or the like. The user terminal may further append the returned data to the leaderboard and it would continue to show subsequent data until there is no cursor in the response.

In some embodiments, the data is expected to be retrieved by the user terminal when the network condition is ideal or weak connection, but the data will be retrieved more slowly in the weak connection. Even though retrieving 1st to 100th data may be slower in the weak connection, the data may still be retrieved by the user terminal, and it doesn't matter because the users may not have scrolled down and seen the subsequent data yet.

Second, if the data request is failed at the beginning of data request, the network condition of the user terminal may be referred to as the “no network connection at the beginning”. In this situation, all the cache data of the first portion of 1st-100th data and the other portions of 101st-3,000th data may be displayed immediately in the beginning. In some embodiments, A request would be transmitted again, but it is intended to simulate data retrieval behavior. In most cases, the API request will fail. Even if the request is successful, the cache data will still be used.

Third, if the data request is failed during data retrieval, the network condition of the user terminal may be referred to as the “lost network connection during data Retrieval”. For example, it is not “First Load” if the user terminal requests on 101st-200th data and the request is failed. After the data request fails, a new request will be transmitted after the retry time until it succeeds. Upon success, the cache will be updated and synchronized. For example, if the request for the 501st-600th data fails, the display will show records up to the 500th data. Meanwhile, the request for the 501st-600th data will continue to be retried until it succeeds. Once the successful response is received, the display will continue with handling the 501st-600th data, and subsequent records may also be requested afterward until there is no cursor in the response.

Return to FIG. 12, 13 and FIG. 14, 15, for each request on network data from the server 10, once the request is “success” (True in S528), the cache unit 208 may set the cache in the cache DB 250 (S530). In some embodiments, if all the requests of data from server 10 are successful (True in S514), which means the request of 1st-100th data is successful, the queue unit 210 may handle all the network data and set the parameter of “First load” as False (S516). Here, steps of handling the network data or handling the cache data may refer to temporarily storing the data without setting or updating the leaderboard on the user terminal. On the other hand, handling leaderboard data may refer to setting or updating the leaderboard on the user terminal. In some embodiments, the queue unit 210 may set the retry count as zero and store the response time (S531) as shown in FIG. 15. In some embodiments, the response time may be used to determine the refresh time of the data and will be described in detail later.

After all the network data is handled, the queue unit 210 may further determine whether to refresh the data or not (S532). In some embodiments, the factor to determine whether to refresh the data may be according to the timeliness of the leaderboard data. For example, the leaderboard in an offline event may be refreshed often in order to reflect the latest ranking of the users. On the other hand, a historical leaderboard may not be refreshed at all because the calculation of the score and ranking are already done. In some embodiments, the leaderboard in an online event may not need to be refreshed often during the event period but need to be refreshed often, for example, one hour right before the end of the event or the like. In some embodiments, the determination of refreshing the data may be made according to the practical need.

If the data does not need to be refreshed (False in S532), the rendering unit 204 may further handle all leaderboard data (S534) by, for example, displaying all the network data on the user terminal. Once there is network data or cache data available, the leaderboard data may be displayed on the user terminal progressively. In some embodiments, the queue unit 210 may further determine whether the API request includes Cursor or not (S536). Here, the “cursor” serves as a special marker or pointer indicating the position or identifier of the next data to be retrieved. If there are subsequent portions of data available, a “cursor” may be included in the response from the server 10. For example, if 1st-100th data is requested successfully, the queue unit 210 may receive a Cursor to indicate that there are subsequent portions of data such as 101st-200th data or the like. If 2,901st-3,000th data are requested successfully, the Cursor may not be returned to the queue unit 210.

In some embodiments, if there is Cursor included in the API request (True in S536), the flow may return to the beginning of FIG. 12 or FIG. 14, and the user terminal may collect a list of requests for requesting data from the server 10 (S502). If there is no Cursor included in the API request (False in S536), the flow may be terminated or ended.

If the data needs to be refreshed (True in S532), the queue unit 210 may further determine whether the parameter of “acquired all data count” is zero or not (S538). Here, the parameter of “acquired all data count” may refer to the number of times all the data are acquired. For example, if there are 3,000 entries of data in server 10 and all the 3,000 entries are requested once, the parameter of “acquired all data count” may be increased by one. On the other hand, if not all the 3,000 data entries are requested at least once, the parameter of “acquired all data count” may be zero.

In some embodiments, if the parameter of “acquired all data count” is zero (True in S538), the rendering unit 204 may further handle all leaderboard data (S540) by, for example, displaying all the network data on the user terminal. The parameter of “acquired all data count” being zero may refer to that all data is not completely requested yet. Once there is network data or cache data available, the leaderboard data may be displayed on the user terminal progressively. For example, the queue unit 201 and rendering unit 204 may request and display the 1st-100th data, 101st-200th data and so on progressively in order.

In some embodiments, the queue unit 210 may further determine whether the API request includes Cursor or not (S542). In some embodiments, if there is Cursor included in the API request (True in S542), the flow may return to the beginning of FIG. 12 or FIG. 14, and the user terminal may collect a list of requests for requesting data from the server 10 (S502). If there is no Cursor included in the API request (False in S542), the parameter of “acquired all data count” may be increased by one (S544), which means all data is acquired at least once.

In some embodiments, if the parameter of “acquired all data count” is not zero (False in S538), the queue unit 210 may further determine whether the API request includes Cursor or not (S546). In some embodiments, if there is Cursor included in the API request (True in S546), the flow may return to the beginning of FIG. 12 or FIG. 14, and the user terminal may collect a list of requests for requesting data from the server 10 (S502).

In some embodiments, if there is no Cursor included in the API request (False in S546), the rendering unit 204 may further handle all leaderboard data (S548) by, for example, displaying all the network data on the user terminal. Furthermore, the parameter of “acquired all data count” may be increased by one (S544). The parameter of “acquired all data count” being not zero may refer to that all data is completely requested. It may also indicate that a complete data at the previous time is displayed on the leaderboard. In that situation, the new leaderboard data may be displayed on the user terminal once all the data is completely requested.

More specifically, if not all data is acquired at least once, the rendering unit 204 may display the data batch by batch. For example, the rendering unit 204 may display the 1st-100th data, 101st-200th or the like on the user terminal in order. On the other hand, if all data is acquired at least once, the rendering unit 204 may display the data until there is no Cursor in the API request. For example, the rendering unit 204 may display the whole 1st-3,000th data at once if both all data is acquired at least once and there is no Cursor in the response from server 10.

In some embodiments, the queue unit 210 may further refresh the data. In some embodiments, the queue unit 210 may clear up the temporarily storing network data and cache data by, for example, setting the network data and the cache data as empty and resetting the parameter of “First load” as true or the like for the preparation of refreshing data (S550). In some embodiments, the flow may return to the beginning of FIG. 12 or FIG. 14, and a list of requests may be collected for refreshing data from the server 10 (S502).

In some embodiments, the queue unit 210 may wait a refresh time before starting to refresh the data (S551) as shown in FIG. 15. Here, the refresh time may be referred to as the interval or frequency at which data is updated or refreshed. It represents the time duration between consecutive updates or refreshes of the data to ensure its accuracy and relevance. In some embodiments, the refresh time may also be a fixed or non-fixed time span. In some embodiments, the refresh time is either a fixed value or increases with the increase in last response time. In some embodiments, the refresh time may be determined flexibly according to the practical need.

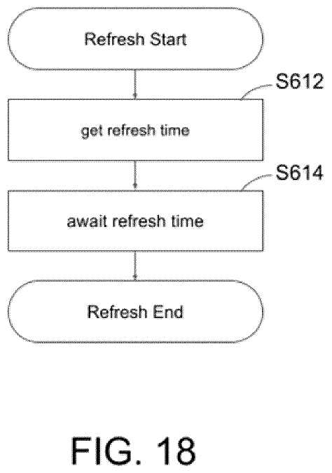

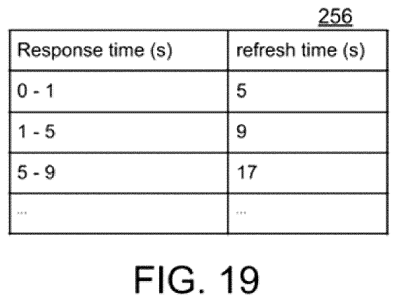

FIG. 18 is a flowchart showing steps of determining refresh time and FIG. 19 shows an exemplary data structure of refresh time look-up table 256 of FIG. 2. As shown in FIG. 18, the queue unit 210 may get the refresh time according to the last response time from server 10 (S612). Here, the last response time may be referred to as the response time stored at step S531 in FIG. 15. Then, the queue unit 210 may wait a refresh time (S614) and further request data for refreshing from the server 10.

The refresh time look-up table 256 may be configured to store the relationship between the response time and the refresh time. In some embodiments, the refresh time look-up table 256 may include the response time and its corresponding refresh time, in association with each other. Once the data from server 10 is requested successfully, the queue unit 210 may store the response time from the server 10 at, for example, data queue DB 252. In some embodiments, the response time may refer to the period from transmitting the request from the user terminal and to receiving the response from the server 10.

In some embodiments, the response time and refresh time may be determined by a look-up table such as the refresh time look-up table 256. As shown in FIG. 19, a range of response time may correspond to a value of refresh time. For example, the range of response time “0-1”, “1-5” and “5-9” may correspond to the value of refresh time “5”, “9” and “17” seconds or the like. In some embodiments, the refresh time may be increased according to the increase of last response time for requesting data from the server 10. In some embodiments, the refresh time may be proportional to the response time. In some embodiments, the refresh time may also follow an arithmetic sequence, geometric sequence, Fibonacci sequence or the like depending on the response time. In some embodiments, the relationship between the response time and refresh time may be determined flexibly according to the practical need.

According to the embodiments, the refresh time to wait before refreshing the data is determined based on the last response time. As the response time increases (indicating a slower backend), the refresh time function would yield a larger refresh time. Therefore, by utilizing this refresh time, the interval between refreshes may be extended to reduce the backend load.

In some embodiments, after all the cache data is displayed on the user terminal at S524, the queue unit 210 may further determine whether to refresh the data or not (S552). If the data does not need to be refreshed (False in S552) the flow may be terminated or ended. If the data needs to be refreshed (True in S532), the queue unit 210 may clear up the temporarily storing network data and cache data by, for example, setting the network data and the cache data as empty and resetting the parameter of “First load” as true or the like for the preparation of refreshing data (S554). In some embodiments, the refresh time may also be a fixed or non-fixed time span. In some embodiments, the flow may return to the beginning of FIG. 12 or FIG. 14, and a list of requests may be collected for refreshing data from the server 10 (S502). In some embodiments, the queue unit 210 may also wait a refresh time before starting to refresh the data (S551) as shown in FIG. 15.

In some embodiments, more than one leaderboard data may be requested by the user terminal at the same time. When the flow returns to step S502, there are two scenarios where the request list is collected. First, it is the first time to request data and it also includes the request after the parameter of “First Load” is reset. Second, the data request is not fully completed and there is a cursor returned. In all other cases, there is no need for request list collection, and it would return null, which would be filtered out in the end.

According to the above embodiments, the determination of retry time and refresh time may be on the terminal side instead of server side. The terminal may determine the retry time and refresh time according to the response and response time from the server 10. In other words, all the determination is from the terminal-side instead of server-side. Therefore, the timing of requesting and displaying data may be optimized and the server load may be reduced.

According to the embodiments, the timing for requesting data from server 10 may be optimized. For example, when encountering a backend issue and unable to retrieve data, a retry time may be set and the terminal may wait the retry time to attempt fetching the data for the next time. Moreover, when encountering a backend issue, it always indicates a problem with normal data retrieval. Repeatedly querying the backend may further accumulate pressure on the backend. Therefore, the setting of retry time according to retry count may lower the pressure on the backend.

According to the embodiments, the timing for refreshing data from server 10 may also be optimized. For example, a refresh time may be set according to the last response time from the backend, and the terminal may wait the refresh time to attempt to refresh the data for the next time. Moreover, repeatedly refreshing data from the backend without considering the last response time may further accumulate pressure on the backend. Therefore, the setting of refresh time according to the last response time may also lower the pressure on the backend.

According to the present disclosure, the requested data, such as the leaderboard data, may be displayed smoothly to the user terminal regardless of the network condition, rather than showing a blank screen. Therefore, the user experience may be improved.

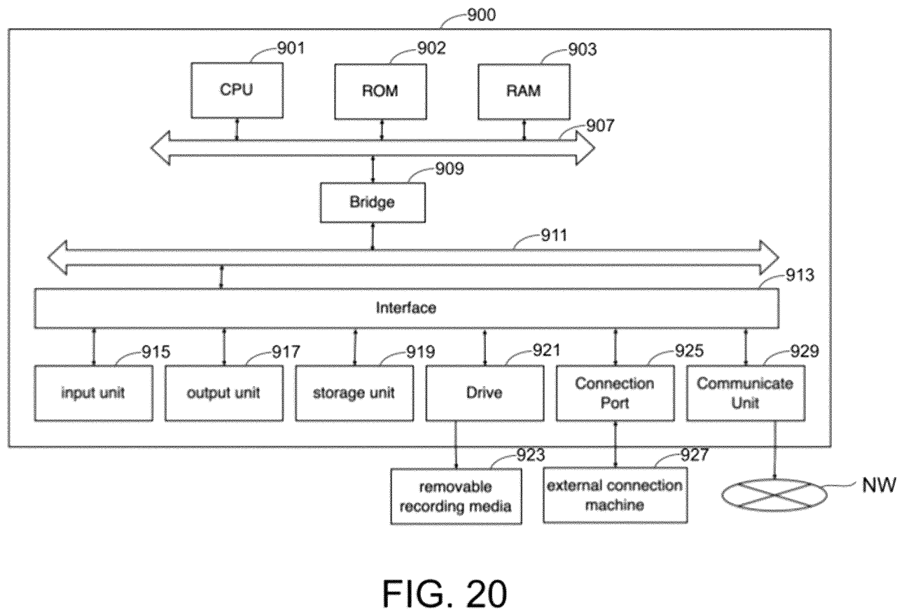

FIG. 20 is a schematic block diagram of computer hardware for carrying out a system configuration and processing according to some embodiments of subject application. The information processing device 900 in FIG. 20 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

What is claimed is:

1. A terminal for handling data in a live streaming platform, comprising one or a plurality of processors, wherein the one or plurality of processors execute a machine-readable instruction to perform:
transmitting a request on a portion of data;
receiving a response of the request;
setting a retry count in response to the response being failed and the portion of data being not the first portion;
determining retry time according to the set retry count; and
transmitting a next request on the portion of data after the retry time.

2. The terminal according to claim 1, wherein
the retry time is either a fixed value or increases with the increase in retry count.

3. The terminal according to claim 1, further comprising:
retrieving cache data of the portion of data and the rest portions of data in response to the request being failed and the portion of data being the first portion; and
displaying the cache data on the terminal.

4. The terminal according to claim 1, further comprising:
storing last response time from a server in response to the response being success; and
determining a refresh time according to the last response time; and
refreshing the portion of data after the refresh time.

5. The terminal according to claim 1, wherein
the refresh time is either a fixed value or increases with the increase in last response time.

6. The terminal according to claim 1, further comprising:
determining whether to refresh the portion of data in response to the response being success;
displaying the portion of data in response to not refreshing the portion of data; and
transmitting a request on a next portion of data in response to there being a cursor in the response.

7. The terminal according to claim 1, further comprising:
determining whether to refresh the portion of data in response to the response being success;
determining whether all portions of data being acquired in response to refreshing the portion of data;
displaying the portion of data in response to not all portions of data being acquired; and
transmitting a request on a next portion of data in response to there being a cursor in the response.

8. The terminal according to claim 1, further comprising:
determining whether to refresh the portion of data in response to the response being success;
determining whether all portions of data being acquired in response to refreshing the portion of data;
displaying all portions of data in response to all portions of data being acquired and there being no cursor in the response.

9. A method for handling data in a live streaming platform, comprising:
transmitting a request on a portion of data;
receiving a response of the request;
setting a retry count in response to the response being failed and the portion of data being not the first portion;
determining retry time according to the set retry count; and
transmitting a next request on the portion of data after the retry time.

10. A non-transitory computer-readable medium including program instructions, that when executed by one or more processors, cause the one or more processors to execute:
transmitting a request on a portion of data;
receiving a response of the request;
setting a retry count in response to the response being failed and the portion of data being not the first portion;
determining retry time according to the set retry count; and
transmitting a next request on the portion of data after the retry time.
